(19) United States
(12) Patent Application Publication
(10) Pub. No.: US 2022/0205527 A1
(43) Pub. Date: Jun. 30, 2022

(54) Utility Terrain Vehicle Transfer Case

(71) Applicant: Profab Machine, Inc.,, Baldwin, WI (US)

(72) Inventor: Larry Peterson, Baldwin, WI (US)

(73) Assignee: Profab Machine, Inc.,, Baldwin, WI (US)

(21) Appl. No.: 17/564,099

(22) Filed: Dec. 28, 2021

Related U.S. Application Data
(60) Provisional application No. 63/132,328, filed on Dec. 30, 2020.

(51) Int. Cl. F16H 57/023; F16H 1/22

(52) U.S. Cl. CPC F16H 57/023; F16H 1/22

(57) ABSTRACT

A transfer case for a utility terrain vehicle includes a housing. An input gear is rotatably coupled to the housing on a first rotational axis. An idler gear assembly is rotatably coupled to the housing on a second rotational axis offset from the first rotational axis. The idler gear assembly includes a major idler gear engaged with the input gear and a minor idler gear. An output gear assembly including an output shaft and an output gear is rotatably coupled to the housing on a third rotational axis offset from the second rotational axis. The output gear is engaged with the minor idler gear of the idler gear assembly.

### CROSS REFERENCE TO RELATED APPLICATIONS

The application claims priority under 35 U.S.C. § 119(e) to U.S. Provisional Application 63/132,328, filed on Dec. 30, 2020. The disclosure of this prior application is considered part of the disclosure of this application and is hereby incorporated by reference in their entireties.

### TECHNICAL FIELD

The present invention relates to utility terrain vehicles, and more particularly, to transfer cases for utility terrain vehicles.

### DESCRIPTION OF THE DRAWINGS

FIGS. 1-12 are perspective views of example ejector pins including the principles of the present disclosure.

Like reference symbols in the various drawings indicate like elements.

### DETAILED DESCRIPTION

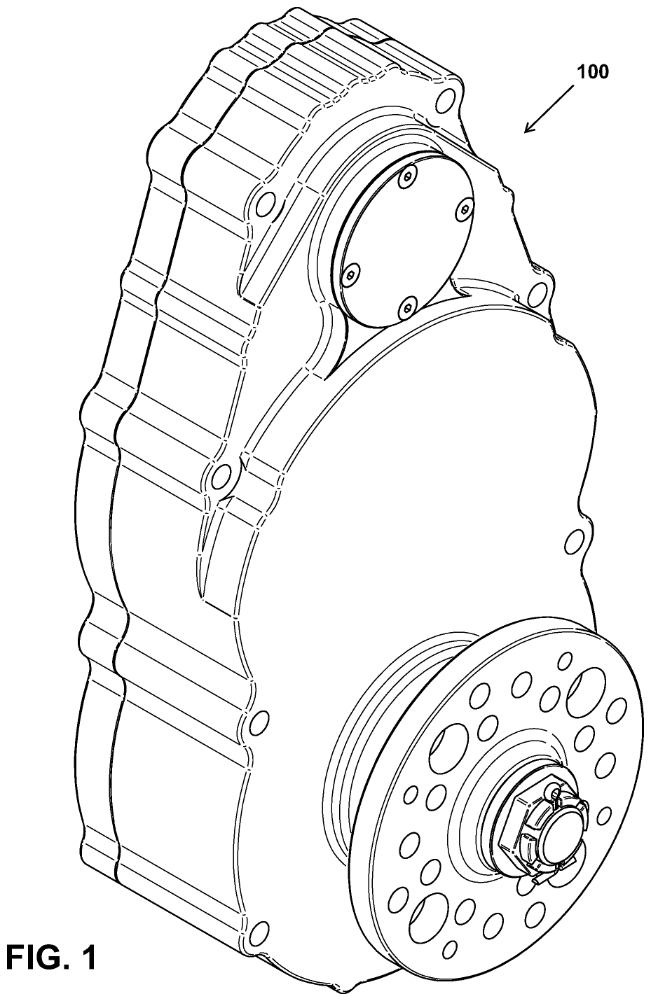

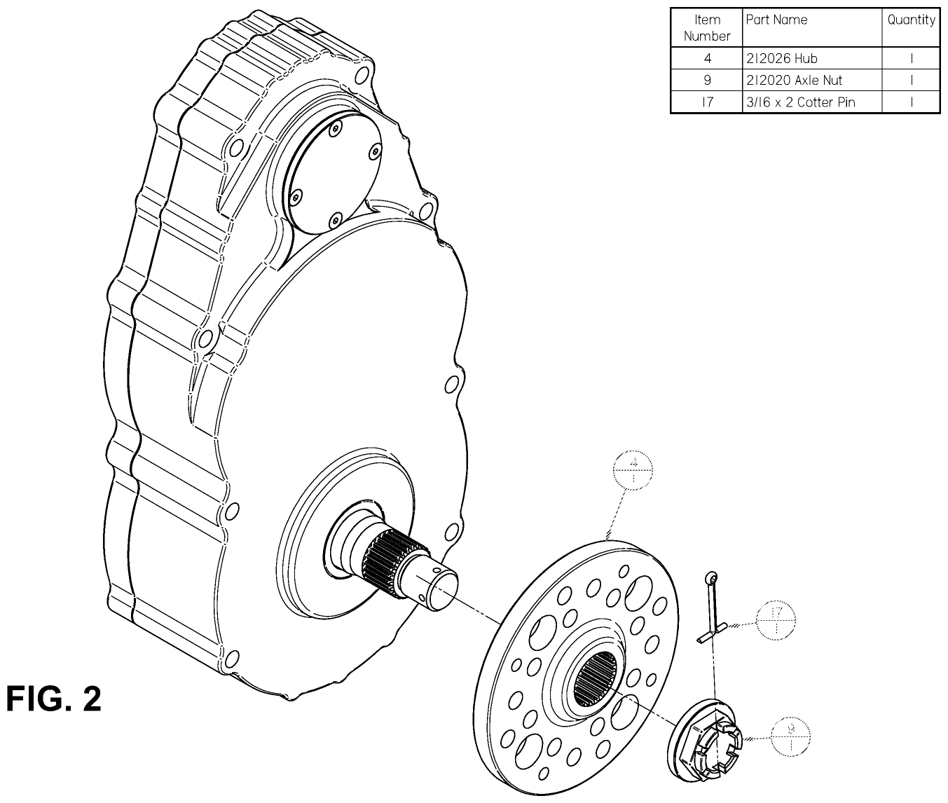

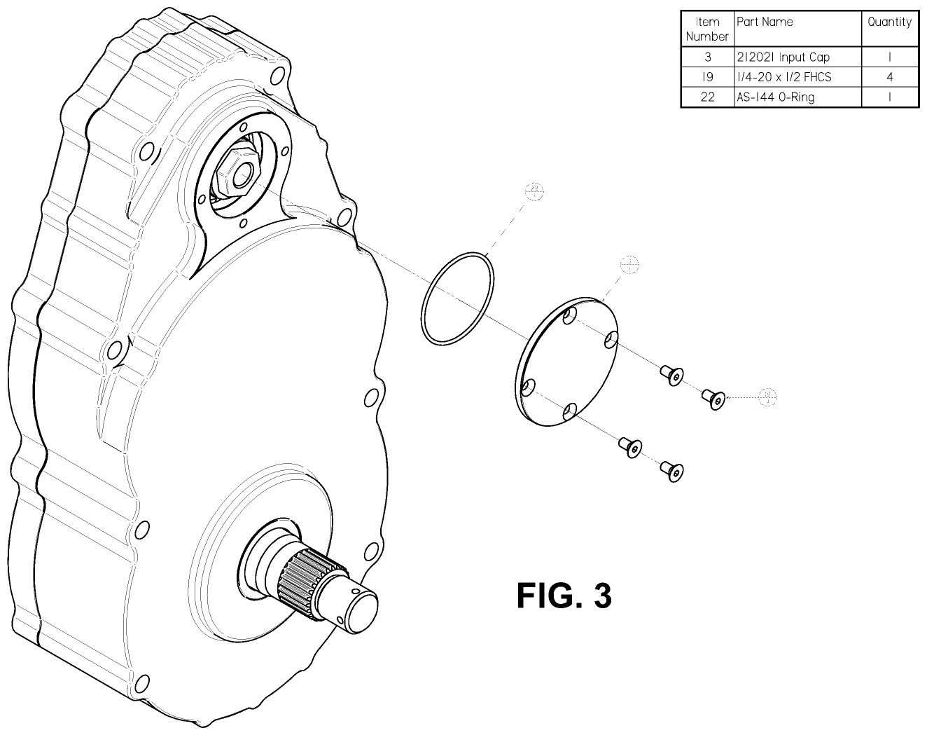

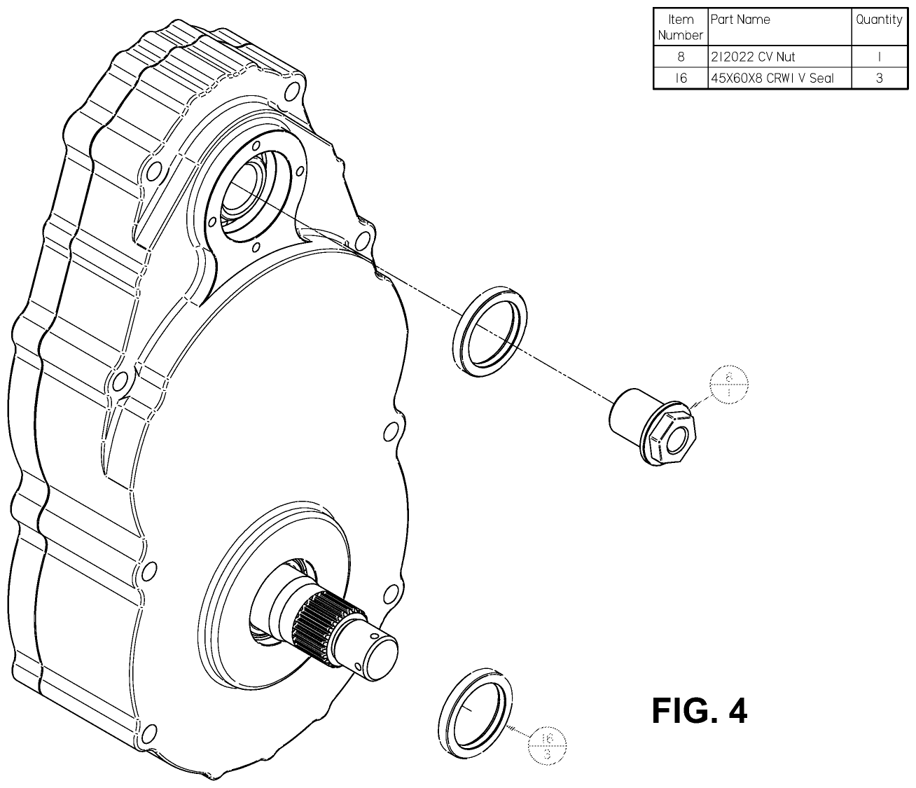

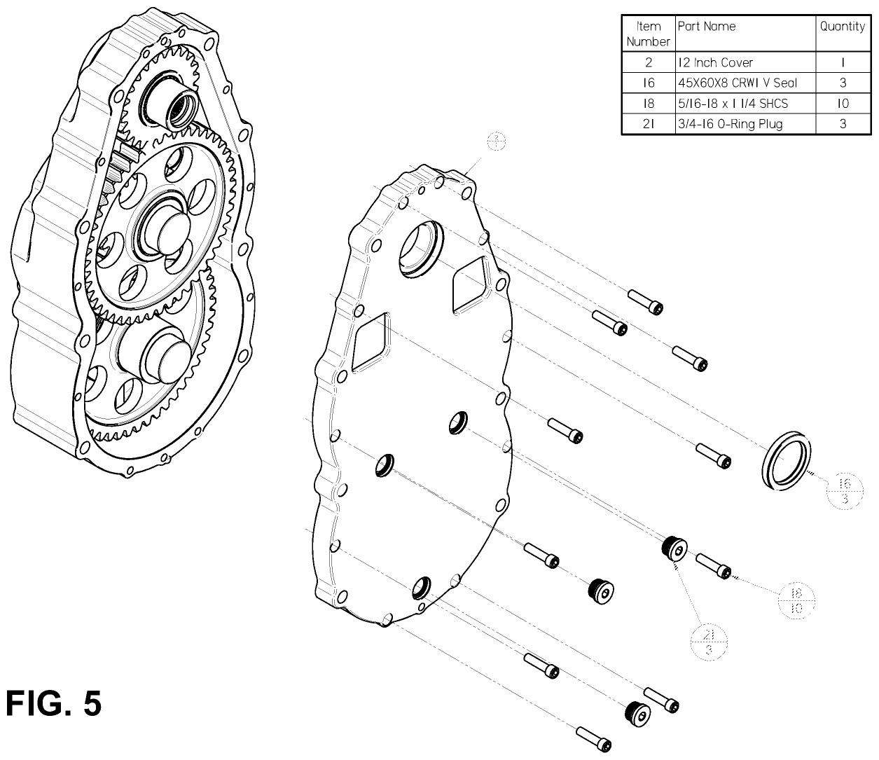

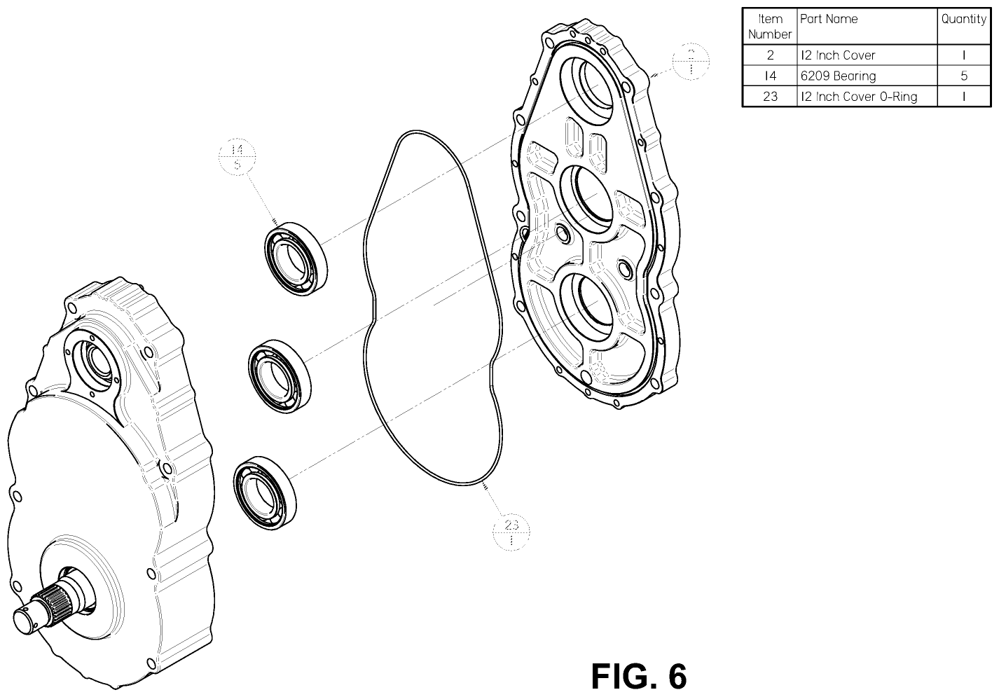

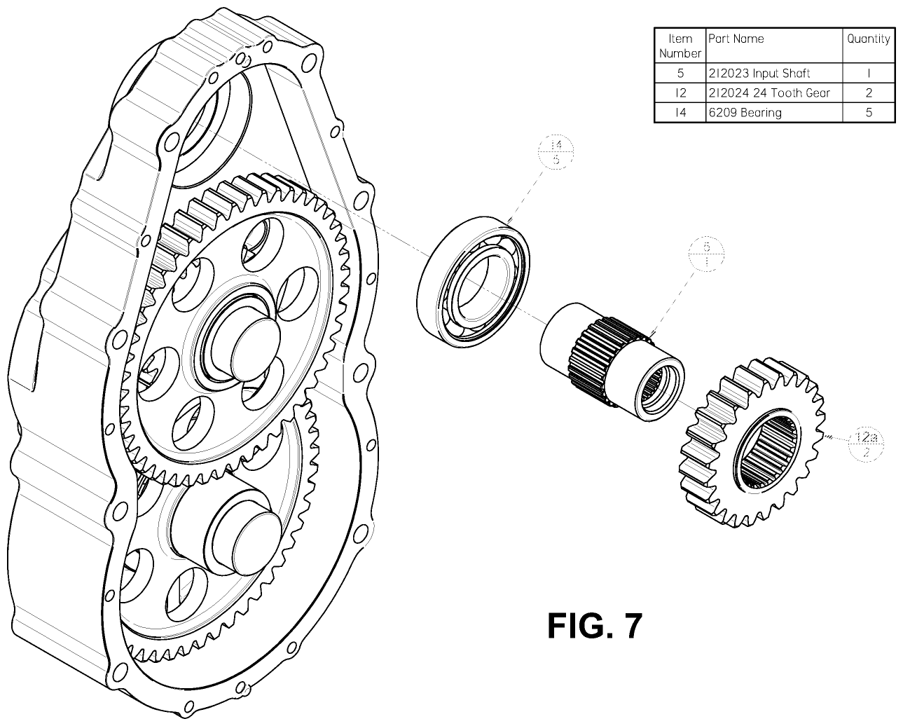

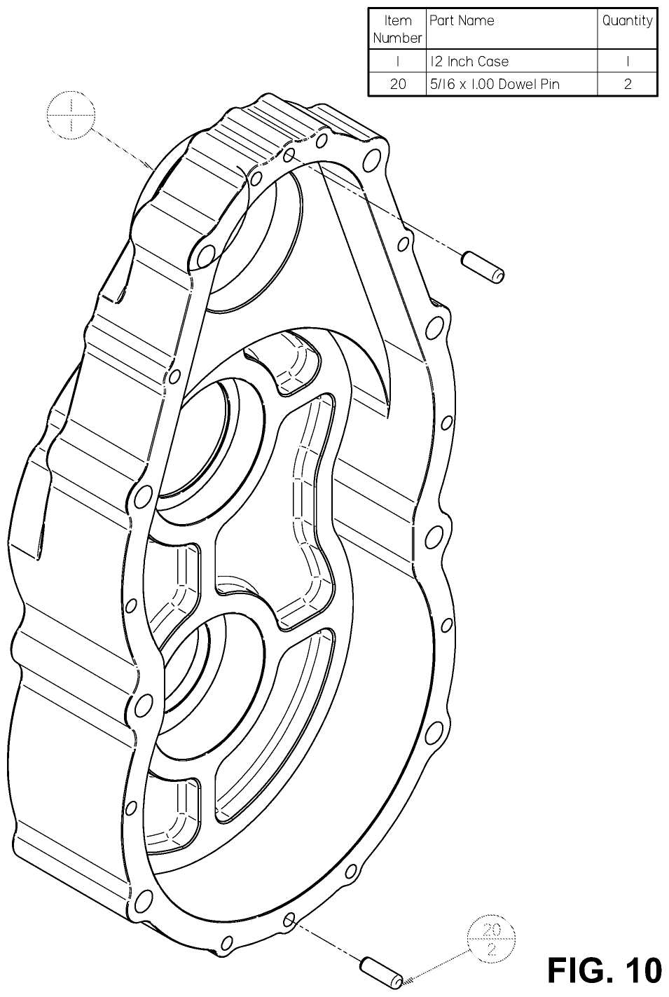

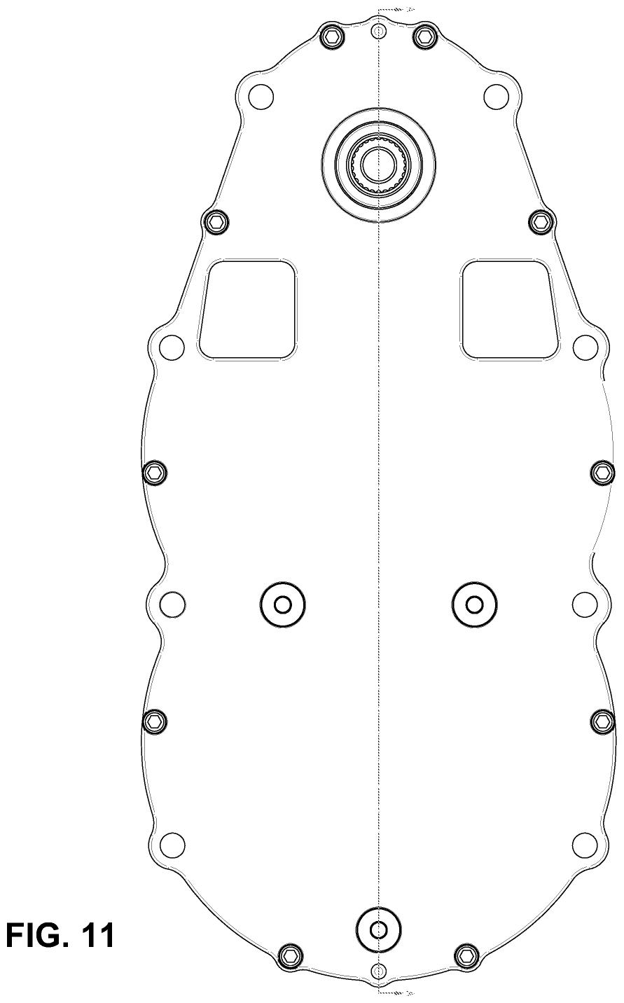

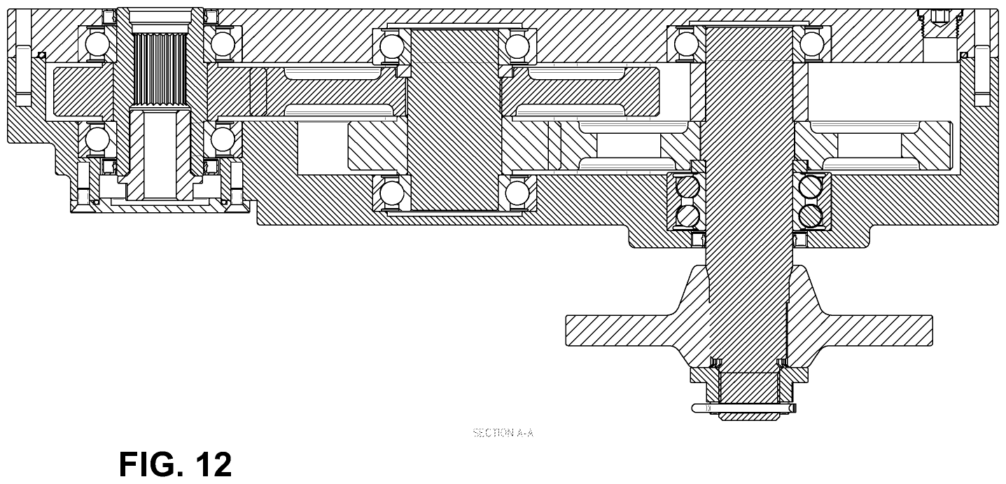

Referring to FIGS. 1-12, a transfer assembly 100 includes a case 1 and a cover 2 removably attached to the case 1 to define an enclosure. The transfer assembly 100 includes three gear assemblies that are axially aligned along a longitudinal axis of the case 1. As shown in FIG. 7, the first gear assembly may be referred to as an input gear assembly and includes an input gear 12a rotatably attached to the case 1 by an input shaft 5.

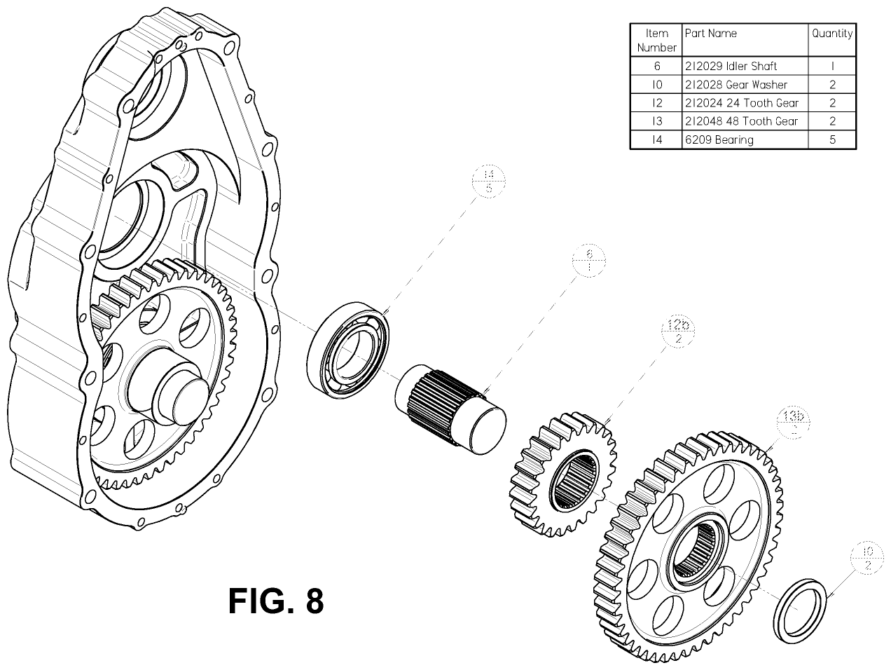

The second gear assembly (FIG. 8) may be referred to as an idler gear assembly and includes a major idler gear 13a rotatably attached to the case 1 by an idler shaft 6. The major idler gear 13a is a spur gear having gear teeth engaged with corresponding gear teeth of the input gear 12a. The idler gear assembly also includes a minor idler gear 12b concentric with and adjacent to the major idler gear 13a. Here, both of the major idler gear 13 and the minor idler gear 12b are rotationally fixed about the idler shaft 6 and the idler shaft 6 is rotationally coupled to the case by a bearing 14. Thus, the minor idler gear 12b and the major idler gear 13a synchronously rotate about a common axis. As shown, the major idler gear 13a has a larger pitch diameter than each of the input gear 12a and the minor idler gear 12b. Thus, the idler gear assembly reduces a rotational velocity Vᵢₙₚᵤₜ of the input gear assembly to a lower rotational velocity V_{idler at} the idler gear assembly by a ratio equivalent to the gear ratio between the input gear 12a and the major idler gear 13a.

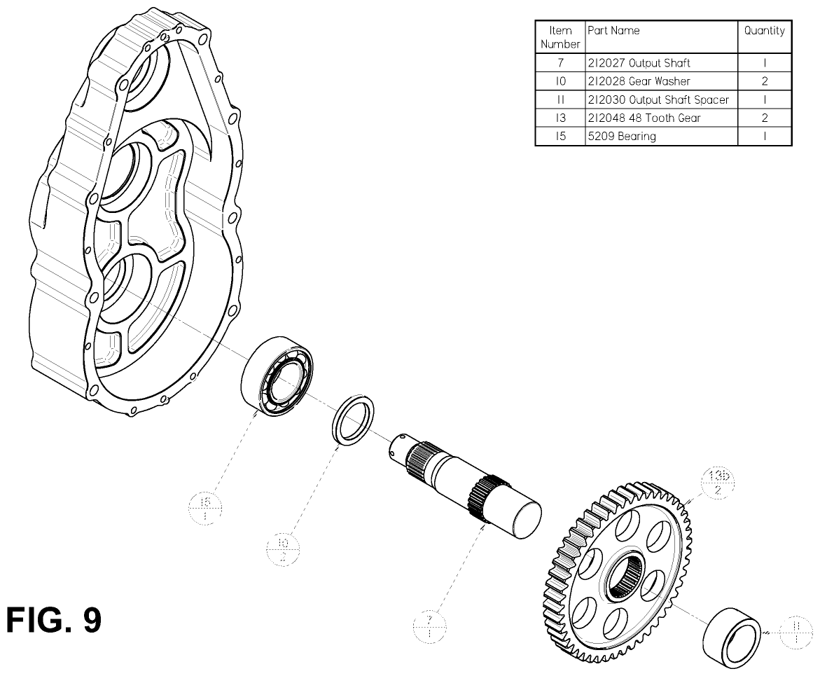

The third gear assembly (FIG. 9) may be referred to as an output gear assembly and includes an output gear 13b rotatably coupled to the case 1 by an output shaft 7. The output gear has gear teeth engaged with the gear teeth of the minor idler gear 12b to provide a second gear reduction from the idler gear assembly to the output gear assembly equivalent to the gear ratio of the minor idler gear 12b and the output gear 13b.

In the illustrated example, each of the input gear 12a and the minor idler gear 12b have the same first pitch diameter (e.g., 24 teeth) and each of the major idler gear 13a and the output gear 13b have the same second pitch diameter (e.g., 48 teeth) to provide the transfer assembly 100 with a total gear reduction of 4:1 (i.e., 2:1×2:1). However, other gear ratios may also be incorporated by changing one or more of the gears 12, 13. The output shaft 5 may include a hub 4 configured for coupling the output shaft 5 to a vehicle axle assembly.

The transfer assembly 100 advantageously allows for advanced gear reduction within a minimized packaging space typically associated with utility terrain vehicles.

Accordingly, the transfer assembly 100 provides relatively high ratios of gear reduction while still fitting within the original space of vehicle. This advanced gear reduction is further facilitated by providing the case 1 with an offset design, whereby the minor idler gear 12b and the output gear 13b are offset within a cavity formed in the case 1 to further minimize packaging space.

A number of implementations have been described. Nevertheless, it will be understood that various modifications may be made without departing from the spirit and scope of the disclosure. Accordingly, other implementations are within the scope of the following claims.

What is claimed is:

1. A transfer case for a utility terrain vehicle, the transfer case comprising:
a housing;
an input gear rotatably coupled to the housing on a first rotational axis;
an idler gear assembly rotatably coupled to the housing on a second rotational axis offset from the first rotational axis, the idler gear assembly including a major idler gear engaged with the input gear and a minor idler gear; and
an output gear assembly including an output shaft and an output gear rotatably coupled to the housing on a third rotational axis offset from the second rotational axis, the output gear engaged with the minor idler gear of the idler gear assembly.
